(19) United States
(12) Patent Application Publication
(10) Pub. No.: US 2018/0187370 A1
(43) Pub. Date: Jul. 5, 2018

(54) Color Matter Dimensional Fabric Dye System

(71) Applicant: Cassandra Lanette Clark, North Pole, AK (US)

(72) Inventor: Cassandra Lanette Clark, North Pole, AK (US)

(21) Appl. No.: 15/394,641

(22) Filed: Dec. 29, 2016

(51) Int. Cl. D06P 3/60; G09B 19/00

(52) U.S. Cl. CPC D06P 3/60; G09B 19/0023

(57) ABSTRACT

The present invention provides a representative model of the universe based on the foundational aspect of the flow of electrical energy within multiple fields of study, formulated within an organic pigment based, all-in-one coloring system, for general public use, that produces unpredictable space type events, through a simulated ‘Big Bang’ model process, on 100% cotton fabric.

The present invention is comprised of: 1) Color Matter (Brilliant Red, Sun Yellow, and Beyond Blue), 2) Dark Matter (black), 3) Magic Drops, 4) Big Bang Technique, 5) Color Matter Color Wheel, 6) Color Matter Dimensional Space Theory.

### BACKGROUND OF THE INVENTION

The invention discussed within this patent is an interactive, educational coloring system that has taken an old time tradition to an entirely new level, providing limitless outcomes, allowing the individual user to create their own stunning harmonious displays of unpredictable space type events (FIG. 1) on 100% cotton fabric, based on scientific concepts formulated within an organic pigment, along with revolutionary new techniques that are simple, easy to use, and presented in a generally acceptable format through the use of the Color Matter Color Wheel (FIG. 2).

Unlike the tie-dye ‘kit’ process presented on the market today, Color Matter, Dark Matter, and Magic Drops dimensional fabric dyes do not require a lengthy education on understanding specific folds or ‘ties’ to achieve a satisfactory result. Dimensional fabric dyes encourage the individual user by providing a ‘no-fail’ environment with the following basic concepts:
1) User can ‘dip’ a piece of 100% cotton fabric into Color Matter diluted with water (6.25%) or Dark Matter diluted with water (6.25%).
2) The individual user is encouraged to mix their own new colors by combining Color Matter colors and Dark Matter.
3) Once the Color Matter, Dark Matter, and Magic Drops have been applied, it is ok to allow varying parts of the said fabric to touch itself or even fold said fabric, if desired, while the garment is still wet with said colors.
4) As long as fabric is wet with Color Matter and/or Dark Matter, the user can manipulate the said color into varying patterns through color mixing of said colors, dipping into said colors (in diluted form), moving said colors with Magic Drops (diluted and undiluted), painting (using diluted and undiluted Magic Drops, Color Matter, and Dark Matter), and by also applying an out-side energy source in the form of a microwave, sunlight, directed heat (such as a hairdryer), and gravity which reveals the dimensional characteristics within the dimensional fabric dyes.

The beginning of the said invention discussed herein began with one simple idea, stated below in hypothetical form:

Given the standard garment dye industry coloring model from the late 80's to mid 90's, using the concept of attraction through the flow of electrical energy (FIG. 3), following a given 4 stage process, based on the variation of polar states of specific textile chemicals and their applications to fabrics in general, is it possible to formulate higher level electrical process concepts, based on the polar states of these same textile chemicals, within an all-in-one organic pigment formulation modelled after the nearest cosmic process in relationship with the earth—the aurora borealis?

For the record of this patent, Appendix I, Affidavit, is incorporated as reference regarding the rights claimed over previous work completed by the inventor, along with her family during the late 80's to mid 90's, in regards to the garment dye industry model standards discussed herein as well as the initial formula structures for Color Matter, Dark Matter, and Magic Drops derived also from the same said work. Said Affidavit, within Appendix I, declares that the inventor holds full property rights to formula's/information/inventions/trade secrets/Color Kit 2000 blends procured by John J. Clark, as owner/operator/developer, of Quality Dye Works, Inc., dissolved shortly after his death in December 2010.

Also, for the record of this patent, all formulas, information, inventions, and trade secrets discussed herein have never been released for general public use nor have any other patents been filed based on any said formula's within this patent.

For the record of this patent, the development of the said invention was not based on any scientific research or federally funded program, however the results of this patent are based on the direct application of the results of the stated hypothesis above to previous said work, including previous prophetic writings by the inventor, since 1995, based on her own personal experiences, recorded within her self-published novel called—Herstory, Revelation of Darkness (Appendix II). Herstory provided the frame-work and reference for the completion of the overall said invention.

As Herstory is based on personal experience and is not linked to any specific scientific research or federally funded endeavor of any kind, it needs to be stated that all correlations to dark matter, dark energy, visible matter, and the electromagnetic spectrum are based on the revelation within this said writing. The comparison's to current research, in order to provide the equations necessary within these fields, along with the Color Matter Dimensional Space Theory, are taken directly from the following articles—Feng, Johnathan, and Trodden, Mark, Dark Worlds, Scientific American, November 2010 (Appendix III), along with Interview by Amir D. Aczel, Dr. Unification, Scientific American, November 2010.

For the purpose of this patent, all references to the auroral potential structure will be taken directly from the research paper written by Cassandra L. Clark during the summer of 1991 while working as a research assistant with Dr. Daniel Weimer, Space Physics Department, Geophysical Institute, University of Alaska, Fairbanks (Appendix IV). Cassandra L. Clark is also a graduate of Engineering Physics, B.S., Embry-Riddle Aeronautical University, Daytona Beach, fall 1992.

Due to the nature of this patent and unusual scientific observation through visual pattern recognition, uncontrolled individual and group settings were utilized during the development of the said invention to allow other individuals to test and manipulate Color Matter, Dark Matter, and Magic Drops, while being observed by the inventor, with minimal instructions allowing the user to experiment with their own ideas. It was through the observation of these observatory groups, by the inventor, that provided key insights and perspective into the extensive capabilities of Color Matter, Dark Matter, and Magic Drops, as well as the cultivation of the Big Bang Technique (“Big Bang”, Wikipedia, Dec. 28, 2016, https://en.wikipedia.org/wiki/Big_Bang.

This project was a sole endeavor by the inventor with no federal funding, or outside sourced income based on the development of this patent.

### SUMMARY OF INVENTION

Unlike computerized models, the said invention is a non-computerized method in which an individual user is guided them from a two dimensional color basis to an entirely new experience of dimensional fabric dyes that can be used to simulate a structured ‘Big Bang’ model in an interactive manner that produces unpredictable space type events imprinted onto 100% cotton fabric. The present invention is comprised of six major components including: 1) Color Matter (Brilliant Red, Sun Yellow, and Beyond Blue), 2) Dark Matter (black), 3) Magic Drops, 4) Big Bang Technique, 5) Color Matter Color Wheel (FIG. 2), 6) Color Matter Dimensional Space Theory.

Color Matter and Dark Matter are organic pigment based, all-in-one, cold water process, no auxiliaries required, dimensional fabric dyes that can be used in straight or diluted form (6.25%) to produce varied dimensional effects depending on the user, applied energy in the form of heat, light, and gravity, as well as varied folds, temperature of the color and environment, water type (hard or soft), color mixing, Magic Drop application, including the weave patterns presented with various types of 100% cotton fabric.

The Color Matter Color Wheel (FIG. 2) concept was designed for ease of use and application by individual users through three interactive stages: Stage 1—Color Matter and Dark Matter are introduced as mixable, dip-able colors that can be applied to 100% cotton fabric, Stage 2—Magic Drops reveal how the user can begin creating dimensional effects, Stage 3—The colored said fabric is manipulated into a theorized pre Big Bang disposition, also known as the Big Bang Technique, and then placed into a 1000 W household microwave or into direct sunlight in order to simulate a structured ‘Big Bang’ model.

The Color Matter Dimensional Space Theory presents a possible theory behind the unpredictable space type events that occur within the 100% cotton fabric used with the said invention by equating the said cotton fabric to the same ‘space and time equated on one fabric’ as discussed in Einstein's General Theory of Relativity (Looking for Extra Dimensions>Why is time a dimension, The Official String Theory Website, accessed Nov. 27, 2016 @4 pm), <www.superstringtheory.com/experm/exper5.html>.

The formulation of Color Matter and Dark Matter depart from the garment dye industry standard model used in the late 80's to mid 90's, by combining 3 of the 4 external separate staged applications, discussed within this patent, into a combined cationic/anionic organic pigment formula revealing an entirely different approach through an all-in-one, internal combined staged application process inspired by modelling near earth cosmic processes within the aurora borealis.

Magic Drops is a whitish opaque dye product created using the same concept as Color Matter and Dark Matter, however it works in opposition to Color Matter and Dark Matter by presenting oppositional effects based on opposing polar states of the given textile chemicals used during formulation. These oppositional effects are the basis for a large portion of the dimensional effects achieved while using the said invention. When Magic Drops is applied to a wet colored piece of 100% cotton fabric colored with Color Matter or Dark Matter, it ‘captures’, the given color it touches allowing all other Color Matter and Dark Matter colors applied to the said piece of fabric to continue to mix and move throughout the remaining process with minimal effect on the areas treated with Magic Drops, until said fabric has completely dried.

Overall, Color Matter, Dark Matter, and Magic Drops present an environment where the movement of color is being understood from an entirely different perspective within an organic pigment formulation that is ‘driven’ internally based on an applied energy source, rather than externally attracted through multiple separate staged applications of the same textile chemicals used in the standard garment dye model presented in the late 80's to mid 90's.

This new thought process has provided an entirely new experience in color for the general user by providing new characteristics within organic pigment formulations that are not only simple and easy to use but are also: 1) Dip-able, 2) Mixable, 3) Moveable, 4) Paintable, 5) Dimensional.

These characteristics provide a ‘no-fail’ environment allowing any individual with or without natural artisitic ability to successfully use the said invention through the use of the Color Matter Color Wheel.

This ‘no-fail’ environment allows the user to ‘touch’ other colors while dipping (usually called color contamination), manipulate Color Matter, Dark Matter, and Magic Drops into varied shapes after fabric has been colored, and the user also has the ability to apply an outside energy source in order to provide further dimensional effects in the form of a microwave, sunlight, directed heat such as a hair dryer, and even gravity.

The dimensional effects created when the said invention is applied to 100% cotton fabric varies in presentation when observed under multiple environmental conditions including day-light, black-light, and photographs.

For general use instructions, any creations using said invention on 100% cotton fabric clothing should be hand-washed, inside out, in cold water only, and hung to dry. Slight loss of pigment will occur depending on the technique used to apply the dimensional fabric dyes.

### BRIEF DESCRIPTION OF FIGURES

FIG. 1|16—As the majority of the said invention is based on visual pattern recognition, a sample set of energy flow patterns imprinted on 100% cotton fabric, have been added as visual evidence to this patent. These visual samples were taken with a basic cell phone camera and were created during the developmental stages of said invention from August 2014 thru November 2016. Row 1 represents some of the initial Color Matter samples, prior to the creation of the Big Bang Technique. These samples were created by using tie-dye folds from the current industry including (left to right) the ‘twist’, ‘scrunch’, and the basic ‘spiral’. Sample rows 2 thru 4 were created using the Big Bang Technique.

FIG. 2|16—The Color Matter Color Wheel is the foundational layout for the basic instructional concept provided for general users to experience the said invention unto creating Dimensional Space Art, as marketed under ColorBucket3000, by the inventor, described within the details of this patent. The center of the wheel (1), is the starting point for the user. Stage 1 provides a basic understanding of preparation and color mixing with Color Matter and Dark Matter in general. Stage 2 begins at the top of the wheel, on the Magic Drops mixing cup circle, and follows in a clockwise manner providing sample views of Color Matter that has been dipped (8), brushed (9), and squirted (10) onto 100% cotton fabric. In continuation, stage 2 provides sample views of dimensional effects that are achieved by the application of Magic Drops onto the said fabric through ‘dropping’ (11), ‘flinging’ (12), and ‘brushing’ (13). Stage 3 provides the user with basic instructions on color movement through the use of the Big Bang Technique to produce Dimensional Space Art, similar to current space type events. The implementation of the microwave in Stage 3 provides the thermal reaction required to create the dimensional imprinted energy flows on the ‘collapsed’ said fabric to create the foundational designs of the said invention, including the Colored Nebula (17), Dark Matter Armory (18), and the Big Bang Bubble (19).

FIG. 3|16—Just as magnets create a magnetic field, electrically-charged objects create electric fields. FIG. 3 represents examples of electric fields between a positive charge and a negative charge as well as the reaction between two positive charges. Students and scientists tend to draw the electric field for positive charges as arrows pointing away from the charge and for negative charges as arrows pointing towards the charge. This diagram and comments are located on the Multi-Wavelength Astronomy website, Astrophysics Section 2: Fields and Particles, http://ecuip.lib.uchicago.edu/wavelength-astronomy/astrophysics/fields-and-particles/03.html, Nov. 3, 2016 @3:26 pm. As quoted on the website, this material is based upon work supported by NASA under Grant Nos. NNX09AD33G and NNX10AE80G issued through the SMD ROSES 2009 Program. Two oppositely charged particles within a fluid medium will present movement or ‘flow’ based on these charges reacting to each other. Color Matter and Dark Matter, in theory, present similar reactions within the formulation itself as each particle within the solution is either negatively (anionic) or positively (cationic) charged.

FIG. 4|16—The spiral shaped auroral potential structure (Dr. Syun-Ichi Akasofu, 1989) represented by the positive and negatively charged fields present in the figure is one of the first presented theories (Dr. Syun-Ichi Akasofu, 1989) for the driving mechanism behind the aurora borealis and is also the inspiration behind the initial Color Matter and Dark Matter formulations.

These formulations began by associating the polar states of specific textile chemicals that could possibly allow for the combination of cationic and anionic solutions within the same formulation. This combination of cationic/anionic solutions created the structure of Color Matter and Dark Matter.

FIG. 4 is the original schematic by Dr. Syun-Ichi Akasofu, referenced within the report written by the inventor, Aug. 13, 1991, Electric Field Observations from the Dynamic Explorer Satellite, while working as research assistant to Dr. Daniel Weimer at the Geophysical Institute, University of Alaska, Fairbanks (Appendix IV).

FIG. 5|16—This presentation of a Solar Wind Magnetosphere Generator (Dr. Syun-Ichi Akasofu, 1989) reveals an overall perspective of positive and negatively charged solar wind particles flowing around the earth and the magnetosphere, forming a comet shaped cavity, that provides the source of energy required to produce the aurora borealis. The auroral potential structure, in theory, is a collector of this flow of energy until it builds up a potential charge strong enough to induce electrons into the upper atmosphere creating the brilliant and colorful displays of the aurora borealis. Color Matter and Dark Matter, in theory, react in a similar manner to the auroral potential structure when an outside energy source in the form of sunlight or the microwave, is applied to a wet, colored sample piece of 100% cotton fabric. The oppositely charged ions within the Color Matter and Dark Matter are ‘excited’ and ‘pushed’, creating harmonious displays of dimensional colors following the flow of energy that has been introduced by the user.

This figure is an original schematic referenced within the report written by the inventor, Aug. 13, 1991, Electric Field Observations from the Dynamic Explorer Satellite, while working as research assistant to Dr. Daniel Weimer, Geophysical Institute, University of Alaska, Fairbanks (Appendix IV).

FIG. 6|16—This figure provides a visual reference to the reaction between Magic Drops and Color Matter in general. This particular sample shows the presentation of diluted Magic Drops (5 parts H2O to 1 part Magic Drops) when ‘dropped’ onto a sample piece of 100% cotton fabric colored with Color Matter (no outside energy source is applied). Diluted Magic Drops will present boundaries that are less distinguishable than undiluted Magic Drops. Whitish areas will also appear surrounding the drop and will be more prevalent in diluted Magic Drops. When the sample piece of fabric is hung to dry, the diluted Magic Drops will move slightly, following gravity (as viewed in FIG. 6). Undiluted Magic Drops show very minimal white areas, if at all, and minimal ‘drop’ in the presence of gravity when hanging to dry.

FIG. 7|16—Step 1 of the Big Bang Technique—hold sample fabric on the upper portion in one hand and begin dropping/collapsing into the other hand while maximizing the exposed edges of the fabric. Sample photo taken from the Color Matter Color Wheel foundational concept mat (FIG. 2).

FIG. 8|16—Step 2 of the Big Bang Technique—Continue collapsing fabric into hand until completely collapsed. Sample photo taken from the Color Matter Color Wheel foundational concept mat (FIG. 2).

FIG. 9|16—Step 3 of the Big Bang Technique—Once the sample fabric is collapsed into the opposite hand, the user will ‘squeeze’ into a spherical shape. Sample photo taken from the Color Matter Color Wheel foundational concept mat (FIG. 2).

FIG. 10|16—The very first sample ever created using what is now called the Big Bang Technique. This sample was created by dipping a sample garment of 100% cotton into Color Matter Beyond Blue, Color Matter Brilliant Red, Color Matter Sun Yellow, and by ‘flinging’ undiluted Magic Drops onto the said sample. The fabric was collapsed and squeezed into a spherical shape and placed into the microwave for approximately 8 minutes. Once removed from the microwave it was hung to dry.

FIG. 11|16—First visual observation by the inventor revealing designs within the imprinted energy flow patterns similar to space type events. The discovery, at the time, presented to the inventor the possibility of a simulated Big Bang type event taking place. Visual sample is a Colored Nebula design placed in the sunlight for approximately 4 hours, pictured along with the Lagoon Nebula found in a teacher corkboard set (ESA/Hubble materials) that was gifted to the inventor shortly before this discovery.

FIG. 12|16—After discovering the similar space type event visible in FIG. 11, the inventor took all samples created, at that time, and compared them to all of the teacher corkboard photo sets. FIG. 12 presents a visible star type formation, in the foreground, discovered within a sample piece of 100% cotton fabric colored with Brilliant Red, Beyond Blue, Sun Yellow, and Magic Drops using the Big Bang Technique. The observed patterns were similar to the space type events presented in the gifted teacher corkboard set—Pinwheel Galaxy (ESA/Hubble materials).

FIG. 13|16—Another visual sample providing evidence to visible formations within a sample piece of 100% cotton fabric revealing similar patterns as the Orion Nebula also found in the teacher corkboard photo set (ESA/Hubble materials). This sample was created using the Big Bang Technique, Dark Matter, Brilliant Red, and Magic Drops (placed into microwave for approximately 8 minutes).

FIG. 14|16—Big Bang Bubble design—sample photo taken from the Color Matter Color Wheel foundational concept mat (FIG. 2).

FIG. 15|16—Colored Nebula design—sample photo taken from the Color Matter Color Wheel foundational concept mat (FIG. 2).

FIG. 16|16—Dark Matter Armory design—sample photo taken from the Color Matter Color Wheel foundational concept mat (FIG. 2).

### DETAILED DESCRIPTION

The initial period towards the creation of the said invention, August 2014, began with the stated hypothesis below, by the inventor.

Given the standard garment dye industry coloring model from the late 80's to mid 90's, using the concept of attraction through the flow of electrical energy, following a given 4 stage process, based on the variation of polar states of specific textile chemicals and their applications to fabrics in general, is it possible to formulate higher level electrical process concepts, based on the polar states of these same textile chemicals, within an all-in-one organic pigment formulation modelled after the nearest cosmic process in relationship with the earth—the aurora borealis?

Taking the stated hypothesis into consideration while observing the basic characteristics employed in the garment dye industry standard models, in regards to organic pigments, from the late 80's to mid 90's, it is noticed that garment dye industry professionals implemented a system based on the flow of energy within electrical processes. For example, cationic acceptor's were created to pre-treat garment's creating the positively charged environment required for the external staged application of negatively charged synthetic organic pigment dispersions to be attracted to. Appendix V provides three sample standard garment dye procedures used during the 1990's.

The standard garment dye industry model used with organic pigments implemented by garment dyers in the late 80's to mid 90's basically followed four stages. Stage one was optional based on the condition of the fabric being colored.
1) Scouring and prepping of the fabric to remove any chemical sizing/softener type residue.
2) Application of cationic pre-treatment to the fabric.
3) Exhaustion of the anionic synthetic organic pigment onto the fabric which usually requires an acidic agent.
4) Exhaustion of the binding agent in order to adhere the pigment to the fabric.

Through the basic understanding of the standard garment dye industry coloring process along with the polar state of given textile chemicals, the basis for modelling higher level energy processes was laid.

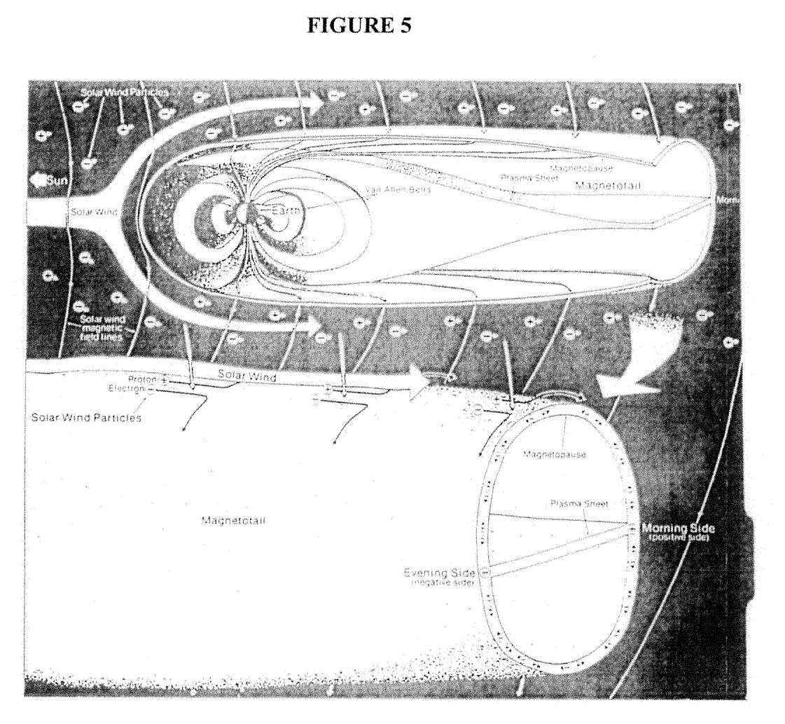

The aurora borealis, the only near earth physical process that is cosmic in nature, reveals interactions between the earth and the universe by the flow of the solar wind released from the sun and interacting with the earth's magnetic field (FIG. 5).

Not only does the aurora represent a true cosmic process that touches the earth, but it is also one of the most amazing natural phenomena that emits color through light. The source of these colored lights are based on an applied energy source in the form of streaming electrons from the solar wind being driven into the atmosphere where they excite elements including atomic oxygen (greenish-white), atomic oxygen occurring in the upper areas of the auroral curtain (dark red), molecular nitrogen (bluish/purple), molecular nitrogen on the lower portion of the auroral curtain (pinkish color). When the electrons ‘smash’ into these elements, they are excited into higher states and release the energy in the form of light which we call the aurora borealis (Aurora Borealis—A Photo Memory, Anchorage, Ak., Copyright 2010,Todd Communications).

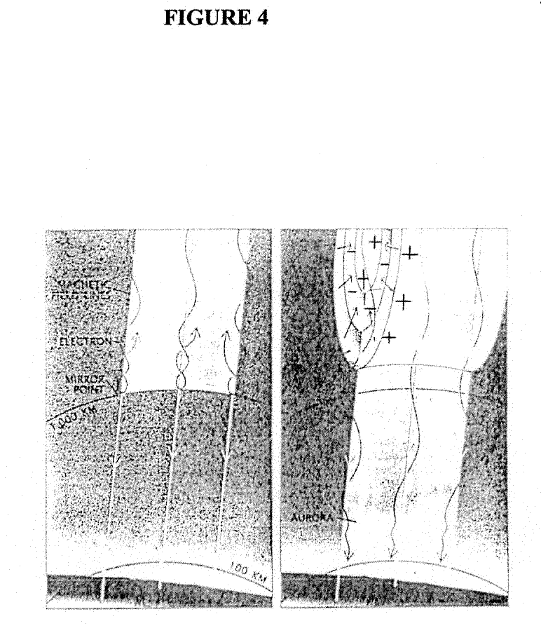

The driving mechanism behind what we see as the aurora borealis, discussed as a possible theory in the 80's by Dr. Syun-Ichi Akasofu, is called the auroral potential structure (FIG. 4).

The spiral shaped formation depicted as the auroral potential structure in FIG. 4 supports positive and negatively charged layers of ions, spiraling together into varied combinations, producing strong electric fields between them. In theory, this structure builds potential by these circulating electrons. It is these high powered electric fields that induce or ‘drive’ highly charged electrons into the upper atmosphere thereby creating the vibrant auroral displays (Appendix IV).

During the development of Color Matter and Dark Matter, the polar groups of given textile chemicals within the garment dye industry standard model used during the late 80's to mid 90's were combined based on the inspiration behind the model of the auroral potential structure in FIG. 4.

Question: How do we model such a unique process within a new formulation of organic pigments?

The first step towards Color Matter and Dark formulation based on cosmic processes, required the correlation of the polar states of given textile chemicals to the configuration of the auroral potential structure concept in FIG. 4. The assumptive equations based on this correlation began as follows:

1) The positively charged fields layered within the auroral potential structure=cationic acceptor.
2) The negatively charged fields layered within the auroral potential structure=anionic organic pigments.
4) The continuous flow of solar radiation into the structure=microwave. (Appendix VI)

Experiments were performed on a trial and error basis through the combination of multiple textile chemicals discussed within this patent including cationic acceptors, anionic pigments, binding agents, and cationic/anionic surfactants. All initial formulations, prior to modelling the auroral potential structure within said formulations, are based on the knowledge obtained during 1989, 1995, and 1996 by the inventor (Appendix I).

### Experimentation

Based on the assumptive equations above our first series of experiments were based on the combination of cationic acceptors and anionic organic pigments. Each series of experiments were devised based on the polar group without any regard to the chemical ‘status’ or purpose of the ionic/non-ionic solutions.

During the creation of the said invention, no microscopes, nor higher level technological equipment or advanced software of any kind was utilized to develop Color Matter, Dark Matter, or Magic Drops. A Gretag McBeth Color Eye 2180, spectrometer, was employed only in the beginning stages in order to provide a base-line color match for future development of colors.

The equipment used for the development of the said invention included a basic laptop ASUS computer with Windows Live Photo Gallery and the Microsoft Office Suite, 2MP and 3MP cell phone camera, HP 2600 Inkjet Printer, Silverson SL2T Lab Mixer (MAX 10,000 rpm) with a shrouded shearing turbine blade, Hamilton Beach Shake Mixer, electronic lab scale (MAX 500 g, d=0.1 g), 1000 Watt/120V/60 Hz SHARP Carousel household microwave, and a standard hand drawn garment dye Crock-Meter for assessing wash fast capabilities of samples.

The warehouse mixer used for completing 5 gallon batches—HILL Mixer with a shrouded, pitched blade driven by a US Motors Enclosed High Efficiency motor HP 3.0, Phase 3 (MAX 2490 rpm) also incorporating a SpeedStar II speed control with AC Variable Frequency Drive, 230 Volts, Phase 1.

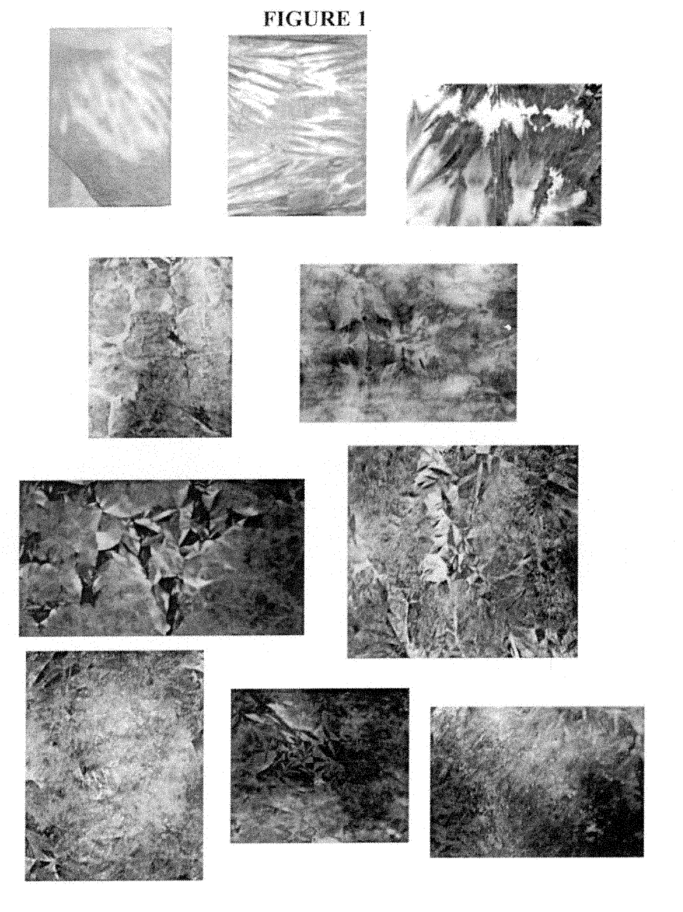

Visual observation and pattern recognition of imprinted energy flows within the sample pieces of 100% cotton fabric after applying the Color Matter Dimensional Fabric Dye System was the only test basis performed during the development of Color Matter, Dark Matter, and Magic Drops in order to determine if a combination of mixtures and samples were successful. FIG. 1 provides visual examples of samples viewed over the period of development from August 2014 through November 2016.

The fundamental aspects viewed to determine acceptance or rejection of a given trial was based on the following:
1) The consistency of the formula—it was important that a fluid consistency was present, absent of air bubbles or large amounts of agglomerated particles. It was also important to view batches over a period of time (from 1 day to 1 month) to ensure that settling would not occur or undesired thickening. It became apparent that Color Matter and Dark Matter produced an environment in which slight settling will occur, however, in order to determine viability, the settled components had to prove that slight stirring re-instated the solution into its original fluid state.
2) The samples of energy flow patterns imprinted onto 100% cotton fabric were judged on the following merits (FIG. 1):
   a. Luster—the brightness of the colors after sample was dry
   b. Texture or amount of flocculated particles on the same fabric when dry
   c. Color mix-ability of Color Matter and Dark Matter after applied to sample piece of 100% cotton fabric in a multi-colored environment where many colors are touching each other—Do they produce pure new mixed colors or brownish muted colors?
   d. Effects produced when an applied energy source is used in the form of a microwave—are Color Matter and Dark Matter dimensional in appearance? Are boundaries distinguishable? Are burn marks apparent?
   e. Dimensional effects of the Magic Drops—do the droplets have a solid boundary separating them from other interactions on the 100% cotton piece of fabric? Do they ‘run’ when gravity is applied? Do they interact with each other?
   f. Penetration—ability of Color Matter, Dark Matter, and Magic Drops to penetrate various weaves of 100% cotton fabrics—how long does it take to dip into color for full penetration?
   g. Wash-fastness using a standard garment dye industry Crock-Meter rating based on visual observation on both dry and wet samples.
   h. Visual pattern recognition of changes applied through various trials and experimentation with Color Matter, Dark Matter, and Magic Drops.

Color Matter, Dark Matter, and Magic Drops formulations are concentrated in nature and are diluted with water when testing sample pieces of 100% cotton fabric. The optimal mixture of water with Color Matter or Dark Matter is 6.25% to 7.0% Color Matter or Dark Matter to 93% to 93.75% water.

The initial formulation structure based on the garment dye industry standard models used in the late 80's to mid 90's is as follows:

### H2O—25%-40%

### Aqueous Pigment Dispersion—25%-39%

### Anionic/Cationic Surfactant 0.1%-0.9%

Binding agent—38%-58%

Applying the auroral potential structure concept to the basic structure above began the formulation of Color Matter and Dark Matter.

### Example 1

Initial experiments for the combination of anionic organic pigments and cationic acceptors began with the following percentages based on observation of the interactions as each one was introduced into an environment of H2O and into the presence of each other. These observations were the basis for determining the initial percentages of cationic acceptors and surfactants used for the initial formulation and the order in which they should be added into the overall process:

Aug. 22, 2014—Color Matter Color Formula Start:

39% thickened aqueous pigment dispersion, 38.9% binding agent, 0.5% surfactant, 8.3% cationic acceptor, 13.3% resin formula.

In order to determine the reactions taking place within this new combination of textile chemicals, each chemical was added according to the list above directly into a 1 gallon bucket of water or dye bath.

The first dye bath created was as follows: 3.11 oz Organic Pigment Red, 3.11 oz Binding Agent, 0.04 oz cationic surfactant, 0.66 oz cationic acceptor, 1.08 oz resin base. This totaled 8 oz of ingredients that were added to 1 gallon of water (6.25%).

The color was changed to Organic Pigment Yellow—again, the ingredients were added directly to 1 gallon of water according to the list above and also for Organic Pigment Red Shade of Blue.

Initial observations showed that flocculation was likely. The process of these ingredients would need to be monitored closely in a manner that would minimize any form of flocculation. Also, from these series of experiments, it was discovered that there was a clear connection between the surfactant reaction to the cationic acceptor within the formulated mixture. The amount of surfactant needs to be in balance with the cationic acceptor as the flocculation increased with increasing amounts of surfactant.

The chosen surfactant at this time will be cationic in nature.

### Example 2

Another series of experiments were performed in order to obtain a visual reaction between the chosen surfactant/cationic acceptor and their reaction to each other when combined in varying combinations.

Seven small plastic cups were set up with 2 grams of cationic acceptor within each cup. Cationic surfactant was added slowly to each cup based on the following measurements: 1) 0 g, 2) 0.05 g, 3) 0.1 g, 4) 0.15 g, 5) 0.2 g, 6) 0.25 g, 7) 0.3 g.

The samples were hand stirred for approximately 15 seconds, and obvious agglomerated particles were present within each cup. In order to understand the interaction of the relationship that was taking place within the 7 cups of combined cationic surfactant and cationic acceptors, 90 grams of water, 8 grams of binding agent, and 8 grams of anionic pigment were also added to the seven cups afterward. Once the solutions were hand stirred for approximately 1 minute each, small samples pieces (approximately 4″×4″, 100% cotton fabric) were dipped into each of the seven cups, squeezed, and laid flat to dry.

The resulting observation of the dried samples dipped into the seven cups provided the visual correlation between the increased amount of surfactant in each cup to observed increased amounts of agglomerated particles adhered to the surface of the sample pieces of 100% cotton fabric that was hand dipped, squeezed, and laid flat to dry. (“How to disburse and stabilize pigments”, March 2015, <www.inkline.gr/inkjet/newtech/tech/dispersion>

These two examples described above provided the basis for structuring further trial and error experiments in order to solidify a Color Matter and Dark Matter formula that proved stable.

The next series of experiments, based on trial and error, were continued using cationic acceptor variations (ranging from 1% to 8%), along with cationic/anionic surfactant variations (ranging from 0.01% to 0.15%) with minimal changes, if any, in the percentages of the anionic pigment, water, binding agent, and resin base.

The trial and error experiments that were conducted based on the variations listed above made it evident that the completion of a formula would depend on the process in which the said textile chemicals were combined. The cationic surfactant and cationic acceptors made this difficult, as the obvious result between them was unstable, however it was believed at the time that the cationic surfactant was required in order to the achieve the dimensional presentations that were appearing.

The initial process created for Color Matter/Dark Matter, listed below, as evident in the first batch created on Sep. 16, 2014. Brilliant Red, Sun Yellow, Beyond Blue, and Dark Matter are all created under the same process and percentages.

First batch of Color Matter—Sun Yellow—Sep. 16, 2014

Made in a 5 gallon bucket.

### Total Batch=20 lbs

Anionic Pigment=45.8%

### Binding Agent=45.8%

### Cationic Surfactant=0.03%

Resin formula=4.4%

### Cationic Acceptor=4.0%

Anionic Pigment is treated with H2O and thickening agent.

Initial Color Matter/Dark Matter process:

Step 1) Add anionic pigment and binding agent into 5 gallon bucket. Blend with a paint paddle attached to a household drill for approximately 5 minutes.

Step 2) Slowly add surfactant and resin formula. Place 5 gallon bucket under Hill Mixer, drop blade just under the surface, baffle up, reverse cycle, 1,000 rpm, for approximately 20 minutes.

Step 3) Add cationic acceptor, very slowly, over a 12 to 15 minute period, 2250 rpm, baffle down, reverse mode, for a total of 45 minutes.

Step 4) Remove from Hill Mixer, place lid over 5 gallon bucket and age for 3 days in a normal warehouse environment.

Initial observation proved that the formula fit within the specifications required, as stated previously within this patent. Also, initial samples from this batch, after 3 days, immediately proved to be successful. It was also apparent that agglomerates would form and fall to the bottom after sitting for 3 days, however, hand-stirring for approximately 3 minutes proved successful in restoring the original consistency.

The first series of market testing began on Jan. 17, 2015 in Ft. Myers, Fla., Fleamaster's Fleamarket, selling Dimensional Space Art imprinted onto 100% cotton fabric using said invention, under the sole proprietorship, by the inventor, DBA ColorBucket3000, until Apr. 30, 2015.

Over time, viewing Color Matter and Dark Matter's performance in a public environment along with multiple trials with uncontrolled observatory groups, occurring between September 2014 and April 2015, it became apparent that large fluctuations in environmental conditions, specifically including heat, multiple users, water type, and color mixing created variables that led to the destabilization of Color Matter, in diluted form, thereby producing extremely large amounts of flocculated particles that would adhere to the surface of the colored 100% cotton piece of fabric after dipping into the diluted Color Matter/Dark Matter dye bath. No direct measurement was determined to provide the information necessary to understand said instability.

After collecting the observed data in regards to the destabilization of Color Matter based on varied environmental conditions, while reviewing the experimental trials which led to the initial Color Matter Formulation, it was decided, by the inventor, that the polar group of the chosen surfactant would need to be changed to anionic instead of cationic, thereby changing the current cationic surfactant to an anionic surfactant.

In continuation, based on the change of the surfactant polar group from cationic to anionic, and also taking into account the direct relationship discovered through previous trials based on the amount of surfactant to the cationic acceptor, an overall decision was made to also reduce the cationic acceptor by 2% within the final formulation of Color Matter and Dark Matter to also assist in stabilization of the final formula.

Continued trial and error experiments occurred until the final approved batch of Color Matter was produced Mar. 16, 2016 following the batch formula below using the said Hill Mixer:

Total batch weight=40 lbs

Anionic Pigment=22.9%

### H2O=22.9%

### Binding Agent=47.8%

Anionic surfactant=0.02%

### Resin=4.4%

Cationic acceptor=2%

Note organic aqueous pigment dispersion was untreated—no thickening agent was present.

All ingredients were processed as stated below:
1) Anionic Pigment and H2O placed in 5 gallon bucket.
2) Bucket was placed under said Hill Mixer, 720 rpm, reverse mode, baffle up, 5 minutes. 1.5 grams of chemical defoamer was added to minimize any ‘foaming’.
3) Surfactant and resin formula added to mixture. Hill Mixer, 990 rpm, baffle up, reverse mode, 10 minutes.
4) Run down 2 minutes on 690 rpm.
5) Hill Mixer speed to 1320-1410 rpm, baffle down just under the surface of mixture, reverse mode, pour cationic acceptor into the mixture very slowly over 10 minute period.
6) Binding Agent added, 1320 rpm, for 30 minutes.
7) 185 g thickening agent added, 1420 rpm, 14 minutes.
8) Rundown by slowly lowering rpms over 8 minute period.

The continuation of market testing for the final batch formula occurred during the summer of 2016, selling Dimensional Space Art creations at the ColorBucket3000 studio located in Fairbanks, Ak., Pioneer Park (Appendix VII) prior to the writing of this patent proving that the changes stated above were the right changes to make in stabilizing Color Matter and Dark Matter. The new formula performed under varied environmental conditions including heavy use, heat and cold fluctuations ranging from 40 degrees to 85 degrees, color mixing, and water type variations with no major flocculation occurring on the hand dipped pieces of 100% cotton fabric. The overall shelf life as of the writing of this patent is 8 months and counting.

### Magic Drops Formulation

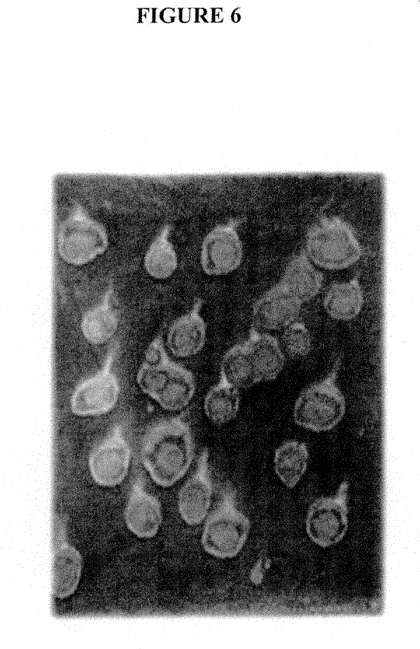

Using cationic acceptors to manipulate organic pigment colored fabric to create varying designs began in 1995 and 1996 (Appendix I). This idea was captured in a proprietary blend that late became Magic Drops in August 2014 (FIG. 6).

The Magic Drops formulation overall occurred in conjunction with Color Matter and Dark Matter and was incorporated through all the trial and error experiments based on visual pattern recognition of applied Magic Drops to said Color Matter and Dark Matter formulas.

For the purpose of the patent, the extensive experimentation will not be discussed, however to say that the surfactant chosen was again the key to creating the right environment for Magic Drops to perform optimally within the Color Matter and Dark Matter environment.

Magic Drops initial formulation was based on the use of an anionic surfactant, while Color Matter and Dark Matter were formulated with a cationic surfactant.

As the destabilization of Color Matter and Dark Matter became apparent, Magic Drops had to be reformulated based on the said changes within Color Matter and Dark Matter. In order to maintain an oppositional presence to Color Matter and Dark Matter, the anionic surfactant within Magic Drops had to be changed to a cationic surfactant revealing the final Magic Drops formula below:

40% Cationic acceptor

### 18% Emulsifier

5% Silicone base

### 1% Cationic Surfactant

### 36% H2O

### Big Bang Technique

The Big Bang Technique is a culmination of perspectives brought together by the inventor and as such will be presented as is:

Once Color Matter, Dark Matter, and Magic Drops have been applied to 100% cotton fabric, this same piece of fabric is held with one hand at the top while collapsing the said fabric into the other hand until completely collapsed. Once collapsed, the said fabric is squeezed into a tight spherical shape. The spherical shaped fabric is then placed into a microwave or direct sunlight for various times, depending on the size of the said fabric and the applied energy source, until the Color Matter, Dark Matter, and Magic Drops just begins to dry on the outside of the spherical shape, while the inside remains damp to wet. At this point, said fabric is removed from the microwave or sunlight and hung to complete the drying process.

Once Color Matter, Dark Matter, and Magic Drops are completely air-dry, the color is set. Heat is not required to set the color only to create dimensional effects as desired by the user.

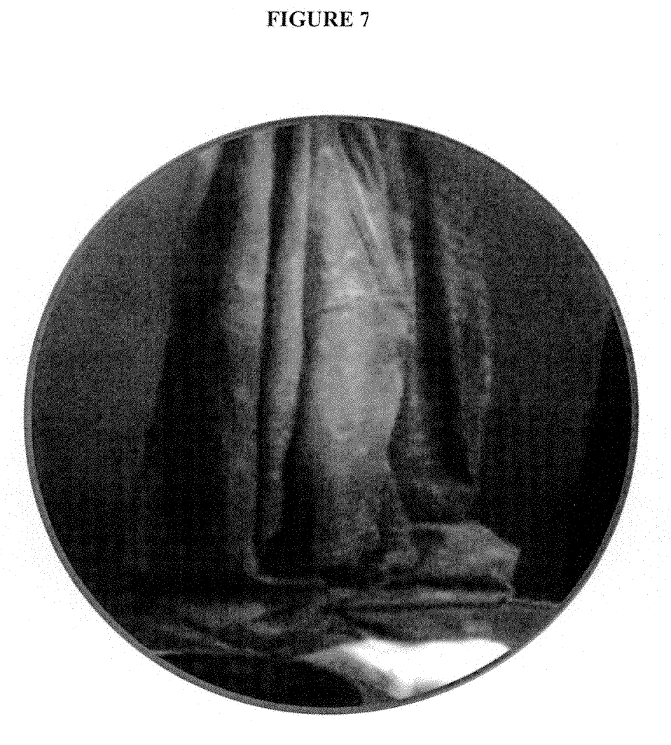

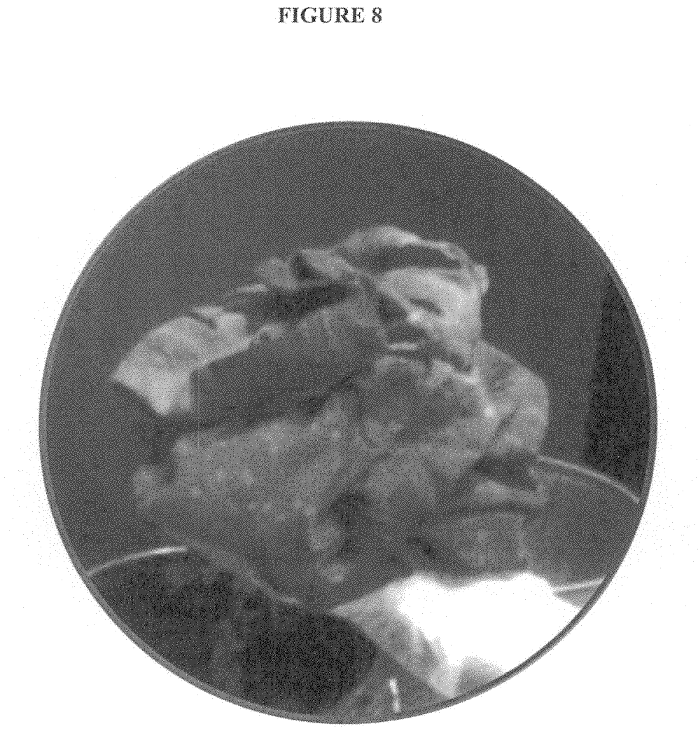

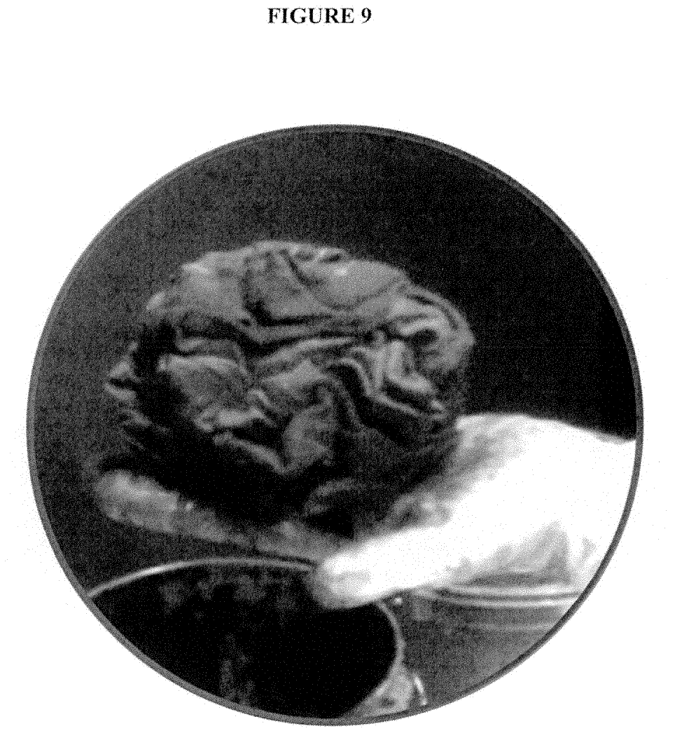

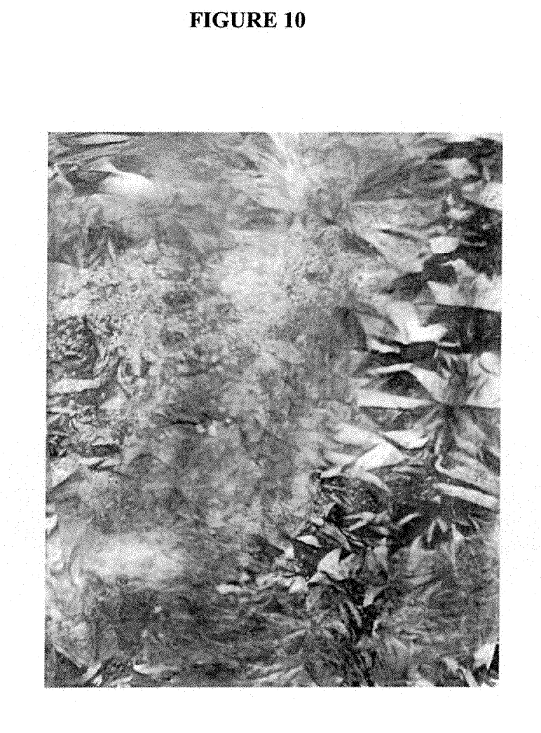

During the development of the said invention, the inventor observed multiple uncontrolled individuals and groups, provided with minimal instructions, and were requested to manipulate and ‘play’ with Color Matter, and Magic Drops on 100% cotton fabric. November 2014, the inventor observed one gentleman in particular ‘dropping’ his work rags into his hands as a method of folding them while working as skilled tradesman in restoration and remodeling. This same method of observed ‘dropping’ (FIG. 7) was applied to a piece of 100% cotton fabric colored with Color Matter, Dark Matter, and Magic Drops and set into a 1000 W household microwave for approximately 8 minutes. The direct visual result is recorded in FIG. 10.

This observed perspective of energy flow patterns was entirely new and also provided an entirely new visual observation based on the use of the Color Matter, Dark Matter, and Magic Drops. It was determined that the ‘dropped’ fabric provided a three dimensional path for which Color Matter and Dark Matter to travel rather than the normal two dimensional thought process behind the current tie-dye folds and patterns presented on the market today.

The visual pattern recognition based on this idea, of shifting from a two dimensional path to a three dimensional path for Color Matter and Dark matter to follow, presented the beginning of the Big Bang Technique, and the Color Matter Dimensional Space Theory.

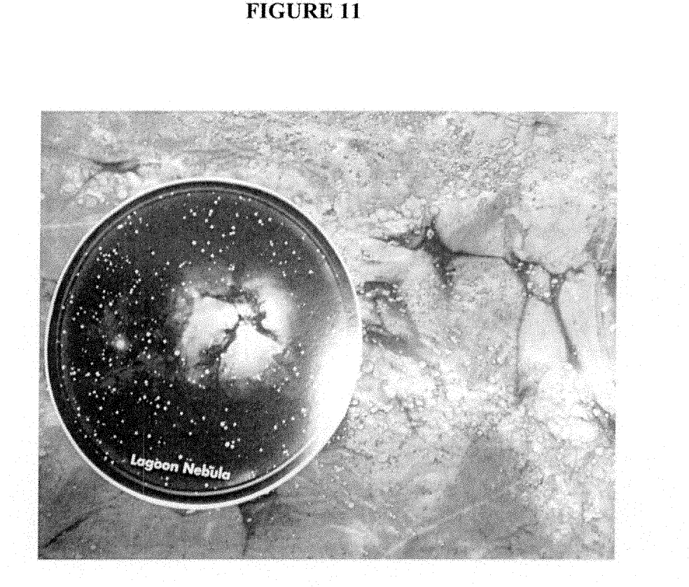

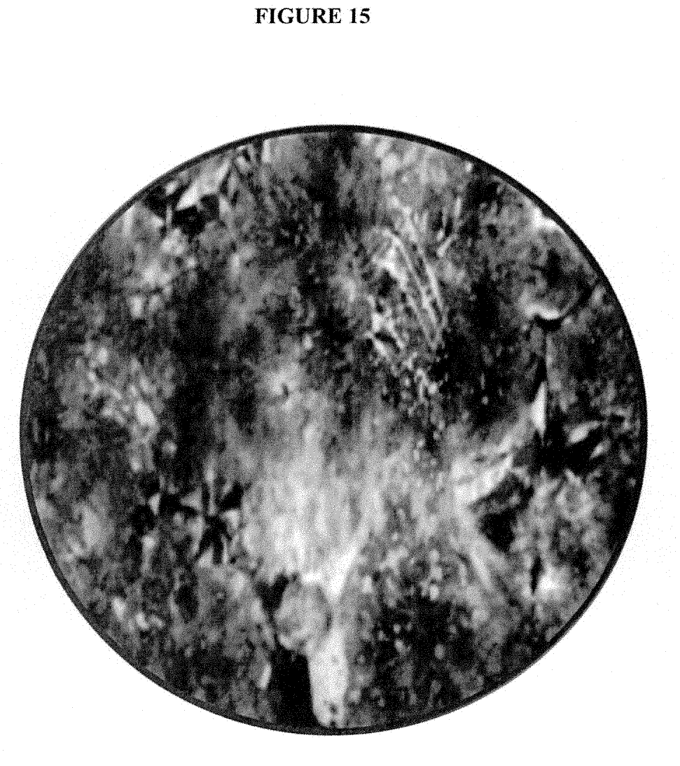

In further discussion, March 2015, based on a series of unexplainable events, the inventor was gifted with a Hubble Telescope Teacher display for corkboards. One in particular, representing the Lagoon Nebula was sitting near a completed Colored Nebula design (FIG. 15) created using Brilliant Red, Sun Yellow, Beyond Blue, and Magic Drops. It was then placed on a paper plate and into direct sunlight for a period of 4 hours. Over this 4 hour period, it was turned every 30 minutes to 1 hour in order to provide maximum exposure to the sunlight from every direction. Afterward, it was hung to dry and then ironed on high cotton setting to remove any ‘wrinkles’ in the fabric. FIG. 11 presents the same teacher corkboard set Hubble photo of the Lagoon Nebula along with the same specific pattern recognized by the inventor within the said Colored Nebula design, as revealing similar recognizable patterns depicting one of the first true space type event patterns that began to reveal the possibility of a miniature simulated Big Bang model taking place within the Color Matter Dimensional Fabric Dye System when applying an outside energy source in the form of sunlight.

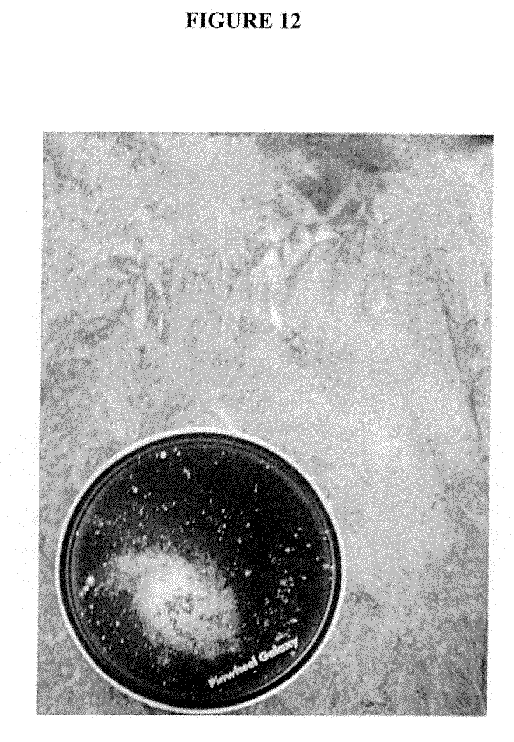

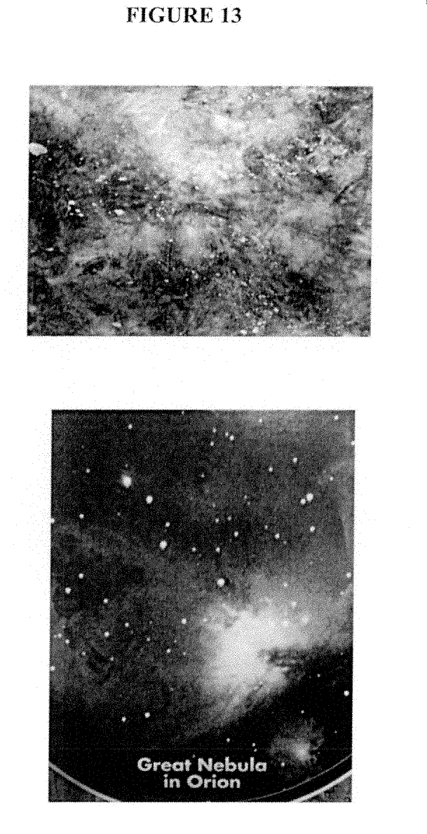

Through continued unpredictable samples using said invention on 100% cotton fabric, following the Big Bang Technique as described above, further similarities began to appear to current space type events imaged in the same Teacher cork-board set of Hubble prints in FIG. 12 and FIG. 13.

This revelation provided the visual recognition requiring an entirely different response by the inventor, bringing into light her own personal prophetic writings self-published Dec. 21, 2013 (a portion is included as evidence to this patent in Appendix II) describing a pre Big Bang disposition, in order to complete the understanding behind the Big Bang Technique, the Color Matter Dimensional Space Theory, as well as the Color Matter Color Wheel.

Excerpt from, Herstory, Revelation of Darkness, page 21 and 22:

For within the One, All Things were. An intense force of enormous magnitude bound together within, closely fixed in place, impervious to the Darkness, continually folding in and upon itself, producing a fiery eternal Light that could not be removed or extinguished. The One longed to be released of this Fire, to share this Light with the Darkness in covenant because there was no other, no other way. For the sum of All Things outwardly produced an eternal Fire of Light, yet inwardly produced an Eternal Love that stood in passion, burning, in unquenchable desire to be Loved as the One loved; Wholy and completely.

What followed was a continued personal journey by the inventor that can only be stated as a result and not as an experimental observation.

Based on the writing above, along with the visual pattern recognition described in the 3 figures also stated above, a clear Big Bang disposition began to reveal itself providing the continued understanding to the creation of the Color Matter Color Wheel, discussed further in this patent.

Through continued trial and error, including said revelation above; three foundational shirt designs were created representing the foundation of the Color Matter Dimensional Fabric Dye System as a whole using the Big Bang Technique.

These designs are written below based on the instructions within the Color Matter Color Wheel concept (Appendix VIII):

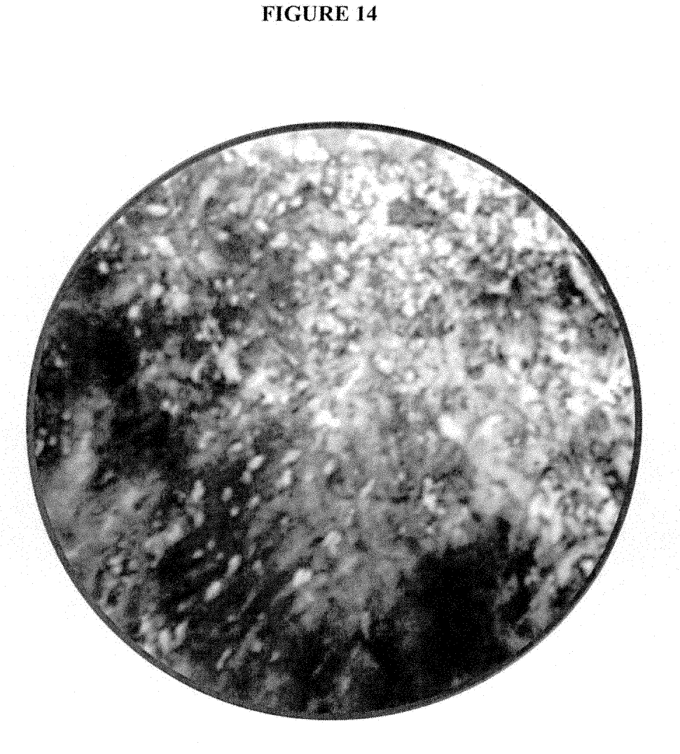

### Big Bang Bubble Shirt Design (FIG. 14)

Follow stage 1 using Brilliant Red, Sun Yellow, Beyond Blue, and Dark Matter.

Center colors in one area on fabric.
Apply Dark Matter on all remaining white areas.
Make sure fabric is completely wet with color.
Do not leave dry areas if placing into a microwave.
WARNING—do not put metal snaps or blended fabrics in microwave. If under 18 years of age, adult supervision required.
Follow stage 2 application of Magic Drops by flinging with paintbrush.
After you have completed the Big Bang fold for stage 3, follow the guidelines below and place the spherical shaped fabric onto a microwave safe ceramic cup and set in microwave.
Heating guidelines for a normal 1,000 Watt household microwave:
Youth size—3 minutes; Adult Small—5 minutes; Adult Large—7 minutes.
If needed, heat for an additional minute.

### Hang to dry.

WARNING: When checking fabric if done—the outside should begin to dry, however the inside will still be damp. Never cook garment until completely dry as a fire can result.
If garment is too wet upon removal from microwave, colors may continue to move when hanging to dry. Be sure to use in well ventilated area.

### Colored Nebula Shirt Design (FIG. 15)

Follow stage 1 with Brilliant Red, Sun Yellow, and Beyond Blue.

Make sure fabric is completely wet with color.
Do not leave dry areas if placing into a microwave.
WARNING—do not put metal snaps or blended fabrics in microwave.
Follow stage 2 application of Magic Drops by flinging with paintbrush.
After you have completed the Big Bang fold for stage 3, follow the guidelines below and place the spherical shaped fabric onto a microwave safe ceramic cup and set in microwave.
For 1,000 Watt microwave:
Youth size—3 minutes; Adult Small—5 minutes; Adult Large—7 minutes.
If needed, heat for an additional minute. Hang to dry.
WARNING: When checking fabric if done—the outside should begin to dry, however the inside will still be slightly.
Never cook garment until completely dry as a fire can result. If garment is too wet upon removing from microwave, colors may continue to move when hanging to dry. Be sure to use in ventilated area.

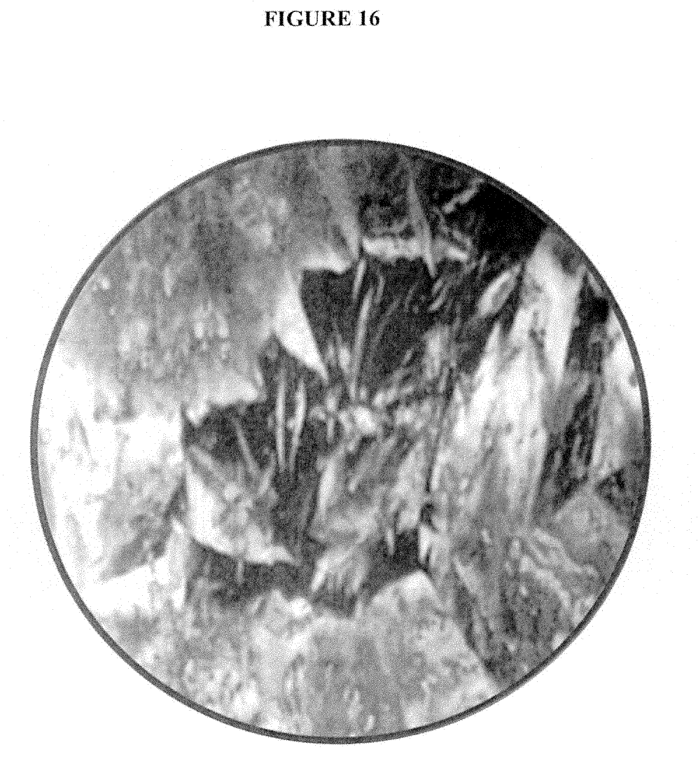

### Dark Matter Armory Shirt Design (FIG. 16)

Follow stage 1 with Dark Matter only.

Make sure fabric is completely wet with color.
Do not leave dry areas if placing into a microwave.
WARNING—do not put metal snaps or blended fabrics in microwave. If under 18 years of age, adult supervision required. Follow stage 2 application of Magic Drops by flinging with paintbrush.
After you have completed the Big Bang fold for stage 3, follow the guidelines below and place the spherical shaped fabric onto a microwave safe ceramic cup and set in microwave.
Heating guidelines for 1,000 Watt household microwave:
Youth size—3 minutes; Adult Small—5 minutes; Adult Large—7 minutes.
If needed, heat for an additional minute. Hang to dry.
WARNING: When checking fabric if done—the outside should begin to dry, however the inside will still be damp. Never cook garment until completely dry as a fire can result. If garment is to wet upon removing from microwave, colors may continue to move when hanging to dry. Be sure to use in ventilated area.

### Color Matter Color Wheel

Based on the breakthroughs discussed above, it was absolutely necessary to present a simple interactive manner in which any individual user could understand three dimensional perspective techniques applied to a series of dimensional fabric dyes. The basic color wheel was implemented as a foundation in order to provide the structure to meet individual users in what they currently understand and was the inspiration behind the circular presentation of the Color Matter Color Wheel mat. Example used: http://www.color-wheel-artist.com/basic-color-wheel.html, previously accessed March 2015, by the inventor.

The Color Matter Color Wheel concept, in completed form, is to be printed on a large, 3′×3′, vinyl mat, providing a safe, non-penetrable, surface in which the individual user can follow a visual interaction unto the creation of their own unpredictable space type events on 100% cotton fabric.

The creation of the Color Matter Color Wheel was completed November 2016 and it was the final stage in the completion of the Color Matter Dimensional Fabric Dye System.

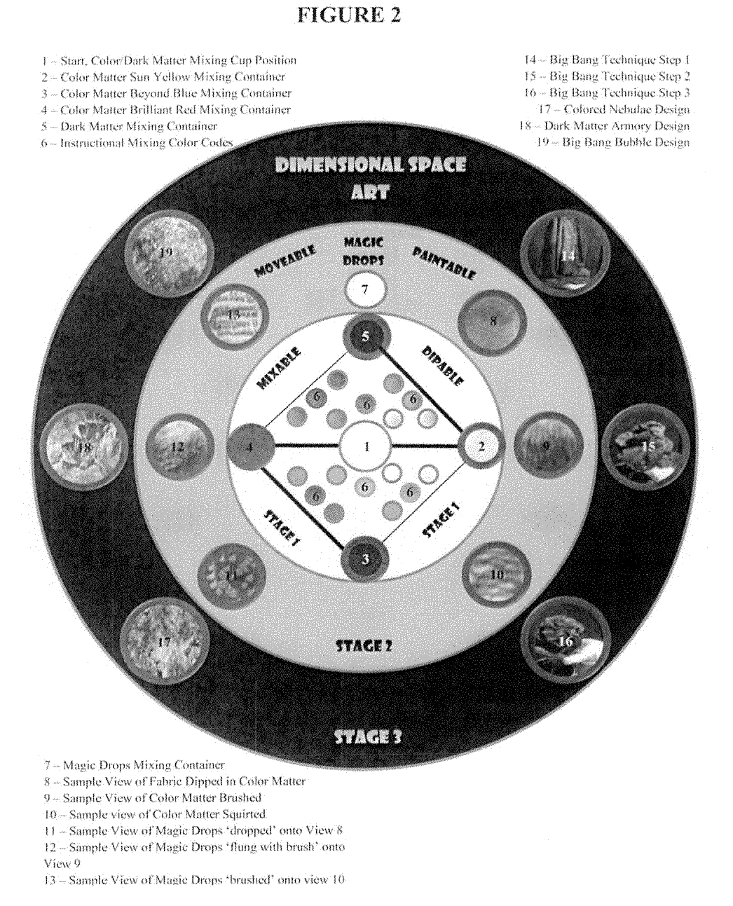

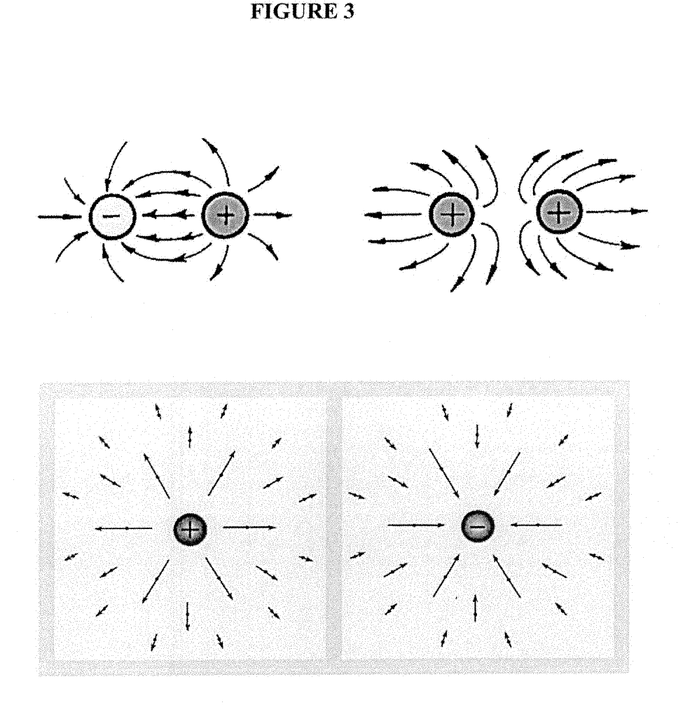

FIG. 2 reveals the Color Matter Color Wheel concept, and the instructions for the Color Matter Color Wheel are added in Appendix VIII.

### Color Matter Dimensional Space Theory

The evolution of the Color Matter Dimensional Fabric Dye System since 2014, in conjunction with Herstory, Revelation of Darkness, provided the way for the culmination of the foundational theory behind the production of the said invention and how it operates. All equations below are based on the work by the inventor, however in order to provide the structure necessary to meet the current scientific community, the following articles were used to provide the necessary definitions from the observer's perspective in order to provide the clarity required in the discussion of the pre-Big Bang disposition being presented. The following articles are as follows:

Feng, Johnathan, and Trodden, Mark, Dark Worlds, Scientific American, November 2010 along with Interview by Amir D. Aczel, Dr. Unification, Scientific American, November 2010.

The Official String Theory Website, Looking for Extra Dimensions>Why is time a Dimension, accessed Nov. 27, 2016, <www.superstringtheory.com/experm/exper5.html>.

The Color Matter Dimensional Space Theory states:

Any piece of 100% cotton fabric that is manipulated by an individual user within the environment of the Color Matter Dimensional Fabric Dye System, represents the same fabric as ‘space and time united on one piece of fabric’, described in the general theory of relativity by Einstein.

As the inventor applied these statements to the said fabric, ‘folding it in and upon itself, (Herstory, Revelation of Darkness, pg 21 and 22), going back in time to the beginning of everything prior to the Big Bang event which revealed the universe we see today’ (as stated by the inventor); a three dimensional spherical shaped seed begins to develop that reveals the fabric of space and time, collapsed, containing the electromagnetic spectrum (representing the Light discussed within Herstory, pg 21 and 22), surrounded by a shell of dark matter (based on pattern recognition and observation by the inventor), with dark energy surrounding on all sides (Darkness, as discussed within Herstory).

The Dark Matter portion of this discovery was one of the most exciting aspects in which further development needs to occur in regards to its possible ‘shell’ orientation, prior to any Big Bang type event, based on the given presentation of completed space type events on observed samples.

The Dark Matter Armory Shirt Design represents the understood universe as a whole in regards to visible matter, dark matter, and dark energy as described by Feng and Trodden (FIG. 18).

Diluted Dark Matter=dark energy
Straight Dark Matter=dark matter
Magic Drops=visible matter

When applying basic linear rectangular measurements to find the area of given Dark Matter presentations, representative of non-baryonic matter in the known universe, along with Dark Energy within the imprinted space type event displayed on the 100% cotton fabric, in comparison to the overall area of the said fabric, the following percentages were calculated based on the Dark Matter Armory shirt design as stated above (FIG. 16):

Approximate area of Dark Matter presentations=38%
Approximate area of Dark Energy presentations=57% (assuming visible matter percentage is equivalent to the visible matter model stated by Feng and Trodden, Dark Worlds)

According to Feng and Trodden, in their article Dark Worlds, visible matter, baryonic matter, comprises approximately 4% of the known universe, dark matter, non-baryonic matter, currently encompasses approximately 23% of the known universe, and dark energy comprises approximately 73% of the known universe.

More recently, discoveries have been made that have changed the known proportions of the universe to the following: 1) dark matter=27%, 2) dark energy=68%, 3) visible matter=5%. (Ferris, Timothy, First Glimpse, National Geographic, January 2015).

The outcome of these basic measurements have provided the basis for claiming the said invention as a non-computerized scientific model of the known universe used in understanding relational patterns between dark matter, dark energy, and visible matter as a whole.

Also, based on the outcome of these simple observations, it is relevant that further study needs to occur in regards to the Color Matter Dimensional Space theory based on the calculation of these percentages presenting similar results to current known universe relationships between dark matter, dark energy, and visible matter.

Overall, the discoveries within this patent have been brought together within the Color Matter Dimensional Space Theory. Equating these said discoveries through pattern recognition based on the said invention along with Herstory, the foundational equations within the Color Matter Dimensional Space Theory were realized and written, thereby revealing the theorized basis behind the unpredictable space type events presenting themselves within energy flow patterns imprinted onto 100% cotton fabric.

The Color Matter Dimensional Fabric Dye System (CMDFDS) presents the following functions for any user using the said invention:

CMDFDS(Color Matter)=electromagnetic spectrum
CMDFDS(Dark Matter (straight))=dark matter
CMDFDS(Dark Matter (diluted))=dark energy
CMDFDS(Magic Drops)=visible matter
CMDFDS(100% cotton fabric)=fabric of space and time
CMDFDS(Big Bang Technique)=folding the fabric of space and time and returning to the beginning of everything, prior to the currently accepted Big Bang theory.
CMDFDS(Microwave)=simulated thermal trigger to ‘Big Bang’ event

What is claimed is:

1) The Color Matter Dye System is an interactive, all-in-one (no auxiliaries required) dimensional fabric dye system comprising: (a) Color Matter and Dark Matter, wherein Color Matter and Dark Matter are dimensional fabric dyes, organic pigment based, wherein the textile chemicals chosen within the formulation were based on their merit to model near earth cosmic processes, utilizing their polar states through the understanding of the natural flow of electrical energy, while also utilizing the basic understanding of the standard garment dye industry model used during the 80's and 90's as the initial formulation basis in order to provide the initial foundational structure of said formulation; (b) Magic Drops, wherein, Magic Drops is a whitish opaque dimensional fabric dye product that is used in opposition to Color Matter and Dark Matter to produce various dimensional effects by creating a polarized presence capturing the organic pigment on the 100% cotton fabric colored with Color Matter and/or Dark Matter; (c) the Big Bang Technique, wherein, the 100% cotton fabric used within the Color Matter Dye System described in this patent, is equated to the same ‘fabric of space and time’ described by Einstein in his General Theory of Relativity, thereby allowing the inventor to structurally model the same ‘fabric of space and time’ by collapsing the said ‘fabric of space and time’ into a spherical seed formation in which an applied energy source in the form of a microwave or sun-light, is used to provide the triggered thermal reaction to create imprinted energy flow patterns within the dimensional fabric dyes on the 100% cotton fabric, which provides clear visual patterns of unpredictable space type events within the colored piece of 100% cotton fabric based on pattern recognition; (d) Color Matter Color Wheel, wherein, the user of the Color Matter Dimensional Fabric Dye System, is given an interactive key, that guides the user on how to create unpredictable space type events, or Dimensional Space Art, imprinted onto 100% cotton through 3 given stages: 1) Stage 1 wherein, Color Matter and Dark Matter are introduced to the user as dip-able and mixable colors that can be applied to 100% cotton fabric through any method the user desires including dipping, squirting, and brushing; 2) Stage 2 wherein, Magic Drops is introduced as a method in which to create dimensional effects within the Color Matter and Dark Matter from Stage 1, by applying in any manner the user chooses including, dropping, splattering, brushing, squirting; 3) Stage 3, wherein, the completed project created by the user through Stage 1 and Stage 2 can systematically be transformed into an unpredictable space type event by following the Big Bang Technique described in Stage 3, while the 100% cotton fabric piece is still wet with Color Matter, Dark Matter, and Magic Drops.

2) claim 2, wherein claim 1, is a non-computerized scientific model used in understanding the structural foundation of universal concepts, through the flow of energy, by applying possible theories representative of pre-Big Bang dispositions while providing further insight into the dynamics of dark matter, dark energy, visible matter, and their relationship to each other based on visual pattern recognition of imprinted energy flows from the use of the Color Matter Dimensional Fabric Dye System on 100% cotton fabric, but not limited to as the Color Matter Dimensional Fabric Dye System presents varied patterns, imprinted within the chosen fabric, of energy flows based on not only the weave of the fabric but the type of fabric, thereby providing multiple foundations in which further imprinted energy flow models can be created in the future.
